(19) United States
(12) Patent Application Publication
(10) Pub. No.: US 2025/0293249 A1
(43) Pub. Date: Sep. 18, 2025

(54) SECONDARY BATTERY, BATTERY PACK, AND VEHICLE

(71) Applicant: KABUSHIKI KAISHA TOSHIBA, Tokyo (JP)

(72) Inventors: Norio TAKAMI, Yokohama (JP); Tomoko SUGIZAKI, Kawasaki (JP); Keigo HOSHINA, Yokohama (JP)

(73) Assignee: KABUSHIKI KAISHA TOSHIBA, Tokyo (JP)

(21) Appl. No.: 19/044,721

(22) Filed: Feb. 4, 2025

(30) Foreign Application Priority Data
Mar. 18, 2024 (JP) 2024-042806

(51) Int. Cl. H01M 4/38; H01M 4/02; H01M 4/485; H01M 4/525; H01M 4/583; H01M 10/0525; H01M 10/0567; H01M 10/0569; H01M 50/284

(52) U.S. Cl. CPC H01M 4/382; H01M 4/485; H01M 4/525; H01M 4/583; H01M 10/0567; H01M 10/0569; H01M 2004/027; H01M 2004/028; H01M 10/0525; H01M 50/284; H01M 2220/20; H01M 2300/0025

(57) ABSTRACT

In general, according to one embodiment, a secondary battery including a positive electrode, a negative electrode, and a nonaqueous electrolyte. The negative electrode includes at least one selected from the group consisting of lithium metal, a lithium alloy, and a compound capable of allowing Li to be inserted and extracted. The nonaqueous electrolyte includes an ionic liquid and 0.5 wt % or more and 30 wt % or less of a urea compound.

### CROSS-REFERENCE TO RELATED APPLICATION

This application is based upon and claims the benefit of priority from Japanese Patent Application No. 2024-042806, filed Mar. 18, 2024, the entire contents of which are incorporated herein by reference.

### FIELD

Embodiments described herein relate generally to a secondary battery, a battery pack, a vehicle, and a stationary power supply.

### BACKGROUND

Nonaqueous electrolyte batteries using lithium metal, a lithium alloy, a lithium compound, or a carbonaceous material as their negative electrodes are expected to be high energy density batteries. Research and development on nonaqueous electrolyte batteries are actively promoted. A lithium-ion battery which includes: a positive electrode including LiCoO₂ or LiMn₂O₄ as an active material; and a negative electrode including a carbonaceous material which allows lithium ions to be inserted in and to be extracted from has been widely put to practical use for portable devices so far. In order to advance application to electric vehicles and stationary storage batteries, in addition to increases in energy density and capacity of a secondary battery, improvements in durable life performance, low temperature performance, and safety are required. In order to increase the energy density of a secondary battery, research and development on a battery including a metal negative electrode (for example, Li, Na, Mg, or Al), a battery including a sulfur-containing positive electrode, or a battery using an air electrode as a positive electrode as a post-lithium ion battery have been conducted. A problem of these post-lithium ion batteries is to achieve both high energy density and durable life performance.

In a battery including a metal negative electrode, the use of Li metal for the metal negative electrode causes a problem such as a short circuit due to dendrite deposition. In addition, if Mg metal is used for the metal negative electrode, overvoltage is large, and there is a problem that a charge and discharge cycle is difficult. On the other hand, in recent years, from the viewpoint of high safety due to the fact that an ionic liquid at room temperature including cations and anions has non-volatility, incombustibility, and non-flammability, the ionic liquid has been studied as an electrolytic solution for a lithium secondary battery using a Li metal negative electrode. However, the ionic liquid is easily redox-decomposed. Therefore, a secondary battery including an ionic liquid as an electrolytic solution has problems of large cycle deterioration, difficult low-temperature operation, and difficult practical application.

### BRIEF DESCRIPTION OF DRAWINGS

FIG. 1 is a partially cutaway cross-sectional view of a secondary battery of an embodiment.

FIG. 2 is a side view of the battery of FIG. 1.

FIG. 3 is a cross-sectional view cutting the secondary battery of the embodiment in a direction perpendicular to an extending direction of a terminal.

FIG. 4 is an enlarged cross-sectional view of the part A of FIG. 3.

FIG. 5 is an exploded perspective view of a battery pack of the embodiment.

FIG. 6 is a block diagram showing an electric circuit of the battery pack of FIG. 5.

FIG. 7 is a schematic drawing showing an example of a vehicle including the secondary battery of the embodiment.

FIG. 8 is a view schematically showing another example of a vehicle according to the embodiment.

FIG. 9 is a block diagram showing an example of a system including a stationary power supply according to an embodiment.

### DETAILED DESCRIPTION

In general, according to one embodiment, a secondary battery including a positive electrode, a negative electrode, and a nonaqueous electrolyte. The negative electrode includes at least one selected from the group consisting of lithium metal, a lithium alloy, and a compound capable of allowing Li to be inserted and extracted. The nonaqueous electrolyte includes an ionic liquid and 0.5 wt % or more and 30 wt % or less of a urea compound.

### First Embodiment

A secondary battery according to an embodiment includes: a positive electrode; a negative electrode containing a negative electrode active material containing at least one selected from the group consisting of lithium metal, a lithium alloy, and a compound capable of allowing Li to be inserted and extracted; and a nonaqueous electrolyte containing an ionic liquid and 0.5 wt % or more and 30 wt % or less of a urea compound. The secondary battery of the embodiment can be, for example, a nonaqueous electrolyte secondary battery. An example of the nonaqueous electrolyte secondary battery includes a lithium secondary battery.

By setting a content of the urea compound in the nonaqueous electrolyte to 0.5 wt % or more and 30 wt % or less, a film (for example, coating film) containing a lithium nitrogen compound can be generated in the negative electrode. The lithium nitrogen compound is a kind of solid electrolyte, and thus has high ion conductivity. Therefore, the film containing a lithium nitrogen compound has low resistance. As a result, reductive decomposition of the ionic liquid in the negative electrode can be suppressed without impairing the ion conductivity of the negative electrode. It is considered that this low-resistance film is formed mainly by reductive decomposition of the urea compound during battery charge. Examples of the lithium nitrogen compound can include Li₃N. Li₃N is excellent in ion conductivity. In the nonaqueous electrolyte, a nitrogen-containing film can be formed on the positive electrode, for example, a positive electrode current collector, by oxidative decomposition of the urea compound. This makes it possible to suppress oxidative decomposition of the ionic liquid in the positive electrode and corrosion of the positive electrode current collector.

Since both oxidative decomposition and reductive decomposition of the ionic liquid can be suppressed and corrosion of the positive electrode current collector can be suppressed, an increase in resistance of the secondary battery can be suppressed. As a result, an efficiency of a charge-discharge reaction of the secondary battery can be enhanced, cycle life performance and discharge rate performance can be improved. In addition, the secondary battery can improve the energy density. Further, since the secondary battery can also be suppressed in self-discharge, it is also excellent in storage performance.

Examples of the urea compound include urea ((NH₂)₂CO) and urea derivatives. Examples of the urea derivatives include N-methylurea and N,N′-dimethylpropyleneurea. The type of the urea compound may be one or two or more.

By setting the content of the urea compound in the nonaqueous electrolyte to 0.5 wt % or more, a low-resistance film (for example, coating film) containing a lithium nitrogen compound having high ion conductivity can be generated in the negative electrode by reductive decomposition of the urea compound in the negative electrode. In addition, a nitrogen-containing film (for example, a nitrogen-containing coating film) can be formed on the positive electrode by oxidative decomposition of the urea compound in the positive electrode. By setting the content of the urea compound in the nonaqueous electrolyte to 30 wt % or less, it is possible to suppress formation of a coating film containing an insulating oxide on the positive electrode and the negative electrode. The coating film containing an insulating oxide causes an increase in resistance of the secondary battery. Therefore, the generation of the insulating oxide may deteriorate the cycle life performance and the discharge rate performance of the secondary battery. Examples of the insulating oxide can include lithium carbonate. A more preferable range of the content of the urea compound in the nonaqueous electrolyte is 1 wt % or more and 10 wt % or less.

Hereinafter, details of the secondary battery will be described. The secondary battery includes a positive electrode, a negative electrode, and a nonaqueous electrolyte, but may include a separator, a container member, and the like. The negative electrode, the positive electrode, and the separator may configure an electrode group. The nonaqueous electrolyte may be held in the electrode group. The form of the electrode group is not particularly limited, and can be, for example, a stacked type, a wound type, or the like.

Hereinafter, details of the nonaqueous electrolyte, the positive electrode, the negative electrode, the separator, and the container member will be described.

### <Nonaqueous Electrolyte>

The nonaqueous electrolyte contains an ionic liquid and 0.5 wt % or more and 30 wt % or less of a urea compound. The nonaqueous electrolyte can be contained in at least one of the positive electrode or the negative electrode. In a case where the secondary battery includes a separator, the nonaqueous electrolyte can be contained in at least one of the positive electrode, the negative electrode, or the separator. A form in which the nonaqueous electrolyte is contained in a member is not particularly limited, and examples thereof can include a form in which the nonaqueous electrolyte is in contact with the target member, and a form in which the nonaqueous electrolyte is held by the target member. The nonaqueous electrolyte is desirably contained in both the positive electrode and the negative electrode, or contained in the positive electrode, the negative electrode, and the separator. This makes it possible to smoothly cause a charge-discharge reaction.

The ionic liquid may include, for example, cations and anions. The cations include, for example, an organic cation and a lithium ion. The organic cation includes at least one cation selected from the group consisting of a 1,3-dialkylimidazolium ion, a trialkylsulfonium ion, an N, N-dialkylpiperidinium ion, and a quaternary ammonium ion. The type of the organic cation may be one or two or more.

The 1,3-dialkylimidazolium ion is preferably 1-methyl-3 ethylimidazolium (MEI).

The trialkylsulfonium ion has a skeleton represented by Chem. (1). Examples of the trialkylsulfonium ion include a trimethylsulfonium ion (S(CH₃)₃⁺: S111 for short), a triethylsulfonium ion (S(C₂H₅)₃⁺: S222 for short), a diethylpropylsulfonium ion (S(C₂H₅)₂(C₃H₇)⁺: S223 for short), and a methylethylpropylsulfonium ion (S(CH₃)(C₂H₅)(C₃H₇)⁺: S123 for short). The triethylsulfonium ion (S222) is preferred. An ionic liquid containing the triethylsulfonium ion as the cation has a low melting point and high ion conductivity.

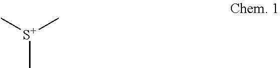

Examples of the N, N-dialkylpiperidinium ion include an N-methyl-N-propylpiperidinium (PP13) ion. The PP13 ion has a wide electrochemically stable potential range.

Examples of the quaternary ammonium ion include a tetraalkylammonium ion and a cyclic ammonium ion. Examples of the tetraalkylammonium ion include a diethylmethylmethoxyethylammonium ion (DEME) and a 1,2-dimethyl-3 propylammonium ion (DMPI). The DEME ion and the DMPI ion are excellent in reductive decomposition resistance.

An ionic liquid containing an organic cation containing at least one of an MEI ion or an S222 ion can have reduced viscosity and thus can have increased ion conductivity.

The anion paired with the organic cation preferably contains one or more of [N(CF₃SO₂)₂]⁻ and [N(FSO₂)₂]⁻. Abbreviations of [N(CF₃SO₂)₂]⁻ and [N(FSO₂)₂]⁻ are referred to as TFSI and FSI, respectively.

The ionic liquid containing at least one cation selected from the group consisting of a 1,3-dialkylimidazolium ion, a trialkylsulfonium ion, an N,N-dialkylpiperidinium ion, and a quaternary ammonium ion, a lithium ion, and an anion containing at least one of [N(CF₃SO₂)₂]⁻ or [N(FSO₂)₂]⁻ has high ion conductivity, and improves the discharge rate performance of the secondary battery.

The lithium ion can be provided, for example, from a lithium salt. The ionic liquid is obtained, for example, by dissolving a lithium salt in an ionic liquid containing no lithium ion. Examples of the ionic liquid containing no lithium ion include an ionic liquid containing an organic cation and an anion. As the lithium salt, LiN(FSO₂)₂ and LiN(CF₃SO₂)₂ are preferred. The type of the lithium salt used may be one or two or more. A concentration of the lithium ion in the nonaqueous electrolyte is preferably 0.5 mol/kg or more and 2 moL/kg or less. An ionic liquid satisfying this range can keep a liquid state in a wide temperature range. A decomposition reaction of the ionic liquid accompanying a battery charge-discharge reaction is suppressed, and the cycle life performance and low temperature performance of the secondary battery can be improved. In addition, in a case where the negative electrode contains metal lithium, interface resistance of the negative electrode can be reduced, so that dendrite deposition can be suppressed, and the large current characteristics and cycle life performance of the secondary battery can be improved. Note that LiN(FSO₂)₂ and LiN(CF₃SO₂)₂ are abbreviated as LiFSI and LiTFSI, respectively.

If the nonaqueous electrolyte includes both of the FSI anion and the urea compound, a film (for example, coating film) can be formed on the positive electrode current collector even at a low lithium ion concentration (for example, 0.5 mol/kg or more and 2 moL/kg or less) of the nonaqueous electrolyte. Therefore, the nonaqueous electrolyte containing the FSI anion and the urea compound can suppress corrosion of the positive electrode current collector. An ionic liquid containing FSI as the anion is more excellent in ion conductivity than an ionic liquid containing TFSI as the anion.

The nonaqueous electrolyte may be substantially formed of an ionic liquid (containing Li ions) and a urea compound, but may contain other components. A content of the ionic liquid (including Li ions) in the nonaqueous electrolyte can be, for example, 70 wt % or more and 99.5 wt % or less. As a result, the lithium nitrogen compound in the negative electrode can be stably present.

The ionic liquid is desirably liquid or gel. A gel nonaqueous electrolyte is obtained, for example, by adding at least one of a polymer material or a gelling agent to a liquid nonaqueous electrolyte to gel the nonaqueous electrolyte.

The polymer material is not particularly limited as long as it can gel the nonaqueous electrolyte containing the ionic liquid, and at least one of a chemical gelling agent or a physical gelling agent can be used. The polymer material can also serve as a gelling agent. Examples of the polymer material include polyacrylonitrile (PAN), polyethylene oxide (PEO), polyvinylidene fluoride (PVdF), and polymethyl methacrylate.

Examples of gelling agents include N,N,N′,N′-tetra(trifluoromethanesulfonyl)-dodecane-1,12-diamine.

A content of a component including at least one of the polymer material or the gelling agent in the nonaqueous electrolyte is preferably 1 wt % or more and 10 wt % or less. Within this range, the low temperature performance and discharge performance can be improved. The type of the component added may be one or two or more.

The nonaqueous electrolyte may contain a fluorine compound. Examples of the fluorine compound include an organic fluorine compound and an inorganic fluorine compound. The type of the fluorine compound used may be one or two or more. The organic fluorine compound can enhance solubility of the urea compound or the lithium salt in a solvent. Examples of the organic fluorine compound include a fluorinated ester and a fluorinated ether. Examples of the fluorinated ester include fluoroethylene carbonate (FEC), difluoroethylene carbonate (DFEC), and 2,2,2-trifluoroethyl methyl carbonate (TFEMC). Examples of the fluorinated ether include 1,1,2,2-tetrafluoro 2,2,2-trifluoroethyl ether (HFE).

Examples of other organic fluorides include methyl 3,3,3-trifluoropropionate (FMP) and 2,2,2-trifluoroethyl acetate (FEA). The type of the organic fluorine compound may be one or two or more.

Since the inorganic fluorine compound is incombustible, the safety of the secondary battery can be enhanced. Examples of the inorganic fluorine compound include lithium difluoro (oxalato) borate.

A content of the fluorine compound in the nonaqueous electrolyte can be, for example, 0.1 wt % or more and 10 wt % or less.

A content of water in the nonaqueous electrolyte may be 1000 ppm by weight or less (including 0 ppm by weight). Thus, the stability of the lithium nitrogen compound present in the negative electrode can be enhanced. The lithium nitrogen compound such as Li₃N is easily decomposed by water, and can be stably present in the ionic liquid.

### <Positive Electrode>

The positive electrode includes a positive electrode active material-containing layer containing a positive electrode active material, and a positive electrode current collector in contact with the positive electrode active material-containing layer.

As the positive electrode active material, different types of materials can be used depending on whether the use of the secondary battery is started from discharge or from charge.

The positive electrode active material can employ a metal oxide or a metal sulfide in a case where the use of the secondary battery is started from discharge. Examples of the metal oxide include a titanium-containing oxide, a niobium-containing oxide, a titanium-niobium-containing oxide, a titanium-niobium-molybdenum-containing oxide, a manganese-containing oxide, and an iron-containing oxide. Examples of the titanium-containing oxide include TiO₂, TiO₂(B), TiNb₂O₇, Ti_{0.2}NbMo_{0.6}O₇, and Li₄Ti₅O₁₂. Examples of the niobium-containing oxide include TiNb₂O₇, Ti_{0.2}NbMo_{0.6}O₇, and Nb₂O₅. Examples of the titanium-niobium-containing oxide include TiNb₂O₇ and Ti_{0.2}NbMo_{0.6}O₇. Examples of the titanium-niobium-molybdenum-containing oxide include Ti_{0.2}NbMo_{0.6}O₇. Examples of the manganese-containing oxide include MnO₂. Examples of the iron-containing oxide include FePO₄. Examples of other metal oxides include V₂O₅. TiNb₂O₇ and Li₄Ti₅O₁₂ can provide good cycle performance. Examples of the metal sulfide include TiS₂, FeS₂, FeS, CuS, Cu₂S, and NiS. FeS and CuS can provide a large capacity.

Examples of the positive electrode active material in a case where the use of the secondary battery is started from charge can include a lithium metal oxide capable of allowing lithium ions to be inserted in and extracted from. Examples of the lithium metal oxide include lithium cobalt oxide (for example, Li_{y}CoO₂, 0<y≤1.1), lithium nickel cobalt manganese oxide (for example, lithium nickel cobalt manganese oxide having a layered structure (for example, Li_{y}NiₐCo_{b}Mn_{c}O₂, a+b+c=1, 0<a, 0<b, 0<c, and 0<y 1.1)), lithium nickel cobalt aluminum oxide (for example, Li_{y}NiₐCo_{b}Al_{c}O₂, a+b+c=1, 0<a, 0<b, 0<c, and 0<y 1.1), lithium iron phosphate (for example, Li_{y}FePO₄, 0<y 1.1), fluorinated lithium iron sulfate (for example, Li_{y}FeSO₄F, 0<y 1.1), lithium manganese iron phosphate (for example, Li_{y}Mn₁₋ₐFeₐPO₄: 0<a≤0.5, and 0<y≤1.1), lithium manganese oxide (for example, Li_{y}Mn₂O₄, 0<y≤1.1), lithium nickel manganese oxide (for example, Li_{y}Ni_{0.5}Mn_{1.5}O₄, 0<y≤1.1), lithium cobalt phosphate (for example, Li_{y}CoPO₄, 0<y≤1.1), and lithium nickel manganese oxide having a spinel structure (for example, LiₓNiₐMn₂₋ₐO₄, 0.4≤a≤0.6, and 0≤x≤1.1). The positive electrode containing, as the positive electrode active material, a lithium metal oxide capable of allowing lithium ions to be inserted in and extracted from can promote reductive decomposition of the urea compound in the negative electrode containing a negative electrode active material containing at least one selected from the group consisting of lithium metal, a lithium alloy, and a compound capable of allowing Li to be inserted in and extracted from.

More preferable examples of the positive electrode active material include lithium nickel manganese oxide having a spinel structure, lithium cobalt oxide, lithium nickel cobalt manganese oxide, lithium nickel cobalt aluminum oxide, lithium cobalt phosphate, and lithium manganese oxide. The positive electrode active material can exhibit a high voltage of 4 V (vs. Li/Li⁺) or more. The positive electrode containing lithium nickel cobalt manganese oxide can provide a high capacity.

The type of the positive electrode active material used may be one or two or more.

The positive electrode active material particles may be in the form of primary particles or secondary particles in which primary particles are aggregated. Further, primary particles and secondary particles may be mixed.

The positive electrode active material-containing layer may contain a conductive agent. Examples of the conductive agent include carbon bodies such as carbon nanofibers, acetylene black, and graphite. The carbon body of the above type can improve an electronic network in the positive electrode. The type of the conductive agent may be one or two or more. A ratio of the conductive agent in the positive electrode active material-containing layer (excluding a weight of the nonaqueous electrolyte) is preferably 5 wt % or more and 40 wt % or less.

The positive electrode active material-containing layer may contain a binder. Examples of the binder include polyvinylidene fluoride (PVdF), polyethylene terephthalate, polysulfone, polyimide, cellulose, and rubber. The binder of the above type is excellent in chemical stability to the nonaqueous electrolyte. A ratio of the binder in the positive electrode active material-containing layer (excluding the weight of the nonaqueous electrolyte) is preferably 1 wt % or more and 10 wt % or less.

For the positive electrode current collector, a porous body, a mesh, a foil, or a combination of two or more thereof can be used. A material for the positive electrode current collector may be, for example, at least one conductive material selected from the group consisting of aluminum, copper, stainless steel, and nickel. A preferred material is aluminum.

A thickness of the positive electrode current collector is 20 μm or less, and is more preferably 15 μm or less.

The thickness of the positive electrode varies depending on the electrode shape and application. In a case where the electrode group structure has a stack structure or a wound structure, the positive electrode thickness is preferably 30 μm or more and 100 μm or less for high-output applications, and 100 μm or more and 500 μm or less for high-energy applications.

In a case where the positive electrode active material-containing layer has a porous structure, a ratio of the nonaqueous electrolyte in the positive electrode active material-containing layer is preferably in a range of 10 wt % or more and 60 wt % or less. By setting the ratio to 10 wt % or more, an effective area of an electrochemical reaction can be increased to realize improvement in battery capacity and resistance suppression. By setting the ratio to 60 wt % or less, a weight ratio of the positive electrode can be increased to improve the battery capacity.

The positive electrode may contain a nitrogen-containing film (for example, a nitrogen-containing coating film). Due to the nitrogen-containing film being present on at least a part of a surface of the positive electrode active material-containing layer, at least a part of a surface of the positive electrode current collector, or at least a part of each of the surfaces of both the positive electrode active material-containing layer and the positive electrode current collector, it is possible to suppress corrosion of the positive electrode current collector and oxidative decomposition of the ionic liquid. The nitrogen-containing film may be present on a part of the target surface or may be present on the entire target surface. The nitrogen-containing film may contain at least one atom selected from the group consisting of Li, C, O, and F.

### <Negative Electrode>

The negative electrode contains, as a negative electrode active material, at least one selected from the group consisting of lithium metal, a lithium alloy, and a compound capable of allowing Li to be inserted in and extracted from. The type of the negative electrode active material used may be one or two or more.

The lithium metal may contain an element other than lithium as an impurity phase (not an alloy phase). On the other hand, the lithium alloy includes an alloy phase in which an element other than lithium forms an alloy phase with lithium.

The lithium metal may contain an element other than lithium as an inevitable impurity (for example, at least one selected from the group consisting of Si, Mg, Ca, Zn, Sn, Fe, Ni, and the like). A purity of the lithium metal can be 90 wt % or more (including 100 wt %). Since the negative electrode containing lithium metal has a high capacity, can increase the battery voltage, and can be made lightweight, the energy density of the secondary battery can be increased. The purity of the lithium metal is desirably higher than 99.5 wt %.

Examples of the lithium alloy include a lithium alloy containing an element that can be alloyed with lithium. Examples of the element that can be alloyed with lithium include Al, Si, Sn, Zn, and Mg. The type of the element used may be one or two or more. Specific examples of the lithium alloy include Li—Al, Li—Si, Li—Sn, Li—Zn, and Li—Mg. A content of the element other than lithium in the lithium alloy can be 0.5 wt % or more and 10 wt % or less.

The lithium metal and the lithium alloy each preferably have a plate shape or a foil shape.

The compound capable of allowing Li to be inserted in and extracted from is a compound capable of allowing lithium or lithium ions to be inserted in and extracted from. Examples of the compound include graphite, a carbonaceous material, a titanium-containing oxide, a niobium-containing oxide, a Si/graphite composite material obtained by compositing a Si powder and a graphite powder, lithium-containing graphite in which lithium ions are inserted in advance, and a lithium-containing carbonaceous material in which lithium ions are inserted in advance. The type of the compound used may be one or two or more.

Examples of the carbonaceous material can include carbon fibers, coke, and hardly-graphitizable carbon.

Examples of the titanium-containing oxide include lithium titanium-containing oxides and titanium oxides.

Examples of the lithium titanium-containing oxide include those having a spinel structure (for example, the general formula: Li_{4/3+a}Ti_{5/3}O₄ (0≤a≤2)), those having a ramsdellite structure (for example, the general formula Li₂₊ₐTi₃O₇ (0≤a≤1)), a lithium titanium-containing oxide represented by Li_{1+b}Ti₂O₄ (0≤b≤1), a lithium titanium-containing oxide represented by Li_{1.1+b}Ti_{1.8}O₄ (0≤b≤1), a lithium titanium-containing oxide represented by Li_{1.07+b}Ti_{1.86}O₄ (0≤b≤1), and a lithium titanium-containing composite oxide containing at least one element selected from the group consisting of Nb, Mo, W, P, V, Sn, Cu, Ni, and Fe.

Examples of the lithium titanium-containing oxide include a lithium titanium-containing composite oxide represented by Li₂₊ₐA_{d}Ti_{6-b}B_{b}O_{14-c} (wherein A is at least one element selected from the group consisting of Na, K, Mg, Ca, and Sr, B is a metal element other than Ti, 0≤a≤5, 0≤b≤6, 0≤c≤0.6, and 0≤d≤3). Li₂₊ₐA_{d}Ti_{6-b}B_{b}O₁₄₋ₑ has a crystal structure of a space group Cmca.

Other examples of the lithium titanium-containing oxide include an orthorhombic titanium-containing oxide. Examples of the orthorhombic titanium-containing oxide include a compound represented by Li₂₊ₐM^{I}_{2-b}Ti_{6-c}M^{II}_{d}O_{14+c}. Here, M^{I} is at least one selected from the group consisting of Sr, Ba, Ca, Mg, Na, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are as follows: 0≤a≤6, 0≤b≤2, 0≤c≤6, 0≤d≤6, and −0.5≤σ≤0.5. A specific example of the orthorhombic titanium-containing composite oxide is Li₂₊ₐNa₂Ti₆O₁₄ (0≤a≤6).

Examples of the titanium oxide include a titanium oxide represented by the general formula LiₐTiO₂ (0≤a≤2). In this case, the composition formula before charging is TiO₂. Examples of the titanium oxide include a titanium oxide having a monoclinic structure (bronze structure (B)), a titanium oxide having a rutile structure, and a titanium oxide having an anatase structure. TiO₂ (B) having a monoclinic structure (bronze structure (B)) is preferable. In addition, low crystalline TiO₂ (B) having a heat treatment temperature of 300 to 600° C. is also preferable.

Examples of the niobium-containing oxide include niobium oxides, niobium titanium-containing oxides, niobium tungsten-containing oxides, and niobium titanium molybdenum-containing oxides.

Examples of the niobium oxide include Nb₂O₅.

Examples of the niobium titanium-containing oxide include a monoclinic niobium titanium-containing oxide, Ti₂Nb₂O₉, Ti₂Nb₁₀O₂₉, TiNb₁₄O₃₇, TiNb₂₄O₆₂, and a substituted niobium titanium composite oxide in which at least a part of Nb and/or Ti is substituted with a different element. Examples of substitution elements include Na, K, Ca, Co, Ni, Si, P, V, Cr, Mo, Ta, Zr, Mn, Fe, Mg, B, Pb and Al. The substituted niobium-titanium composite oxide may contain one substitution element, or may contain two or more substitution elements.

Examples of the monoclinic niobium titanium-containing oxide include those represented by the general formula Li_{c}TiNb_{d}O₇ (0≤c≤5 and 1≤d≤4). A more preferable composition is TiNb₂O₇.

An example of the monoclinic niobium titanium-containing oxide includes a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formula are as follows: 0≤x≤5, 0≤y<1, 0≤z<2, and −0.3≤δ≤0.3.

Another example of the monoclinic niobium titanium-containing oxide includes a compound represented by Ti_{1-y}M3_{y+z}Nb_{2-z}O_{7-δ}. Here, M3 is at least one selected from the group consisting of Mg, Fe, Ni, Co, W, Ta, and Mo. The respective subscripts in the composition formula are as follows: 0≤y<1, 0≤z<2, and −0.3≤δ≤0.3.

Examples of the niobium tungsten-containing oxide include Nb₁₄W₃O₄₄, Nb₁₆W₅O₅₅, and Nb₁₈W₈O₆₉.

Examples of the niobium titanium molybdenum-containing oxide include a tetragonal titanium-niobium-molybdenum composite oxide represented by the general formula LiₐTi_{b}Nb_{2-2d}Mo_{c+2d}O_{2b+5+3c} (the subscripts a, b, c, and d are preferably within the ranges of 0≤a≤b+4+3c, 0.3≤b≤1.6, 0.3≤c<1.6, and 0≤d<0.4, respectively) and a composite oxide represented by the general formula LiₐM_{b}NbMo_{c}O_{d}, in which M is at least one selected from the group consisting of Ti, V, Ta, Fe, Co, Mn, Ni, Bi, Sb, As, P, Cr, W, B, Na, K, Mg, Al, Ca, Y, and Si, and 0≤a≤b+2+3c, 0≤b≤1.4, 0≤c≤0.5, and 2.33≤d/(1+b+c)≤2.50.

The negative electrode active material containing at least one of lithium metal, a lithium alloy, graphite, a carbonaceous material, or Li_{c}TiNb_{d}O₇ (0≤c≤5 and 1≤d≤4) can cause reductive decomposition of the urea compound at a lithium or lithium ion inserted/extracted potential. Therefore, the negative electrode active material can enhance an effect of suppressing the reductive decomposition of the ionic liquid. The negative electrode active material containing lithium metal and/or a lithium alloy is also excellent in energy density of the secondary battery.

The negative electrode may include a negative electrode active material-containing layer. The negative electrode active material-containing layer may contain a conductive agent and/or a binder.

As the conductive agent, for example, a carbon material, a metal compound powder, a metal powder, or the like can be used. Examples of the carbon material include acetylene black, carbon black, coke, carbon fibers, graphite, carbon nanotubes, and carbon nanofibers. The BET specific surface area by N₂ adsorption of the carbon material is preferably 10 m²/g or more. Examples of the metal compound powder include powders of TiO, TiC, and TiN. Examples of the metal powder include powders of Al, Ni, Cu, and Fe. Preferred examples of the conductive agent include coke having a heat treatment temperature of 800° C. to 2000° C. and an average particle size of 10 μm or less, graphite, acetylene black, carbon fibers having an average fiber diameter of 1 μm or less, and TiO powder. According to one or more selected from these, it is possible to reduce the electrode resistance and improve the cycle life performance. The type of the conductive agent may be one or two or more.

Examples of the binder include polytetrafluoroethylene (PTFE), polyvinylidene fluoride (PVdF), fluororubber, acrylic rubber, styrene butadiene rubber, core-shell binder, polyimide, and carboxymethyl cellulose (CMC). The type of the binder may be one or two or more.

The negative electrode active material-containing layer containing a compound capable of allowing Li to be inserted in and extracted from (hereinafter, referred to as a first compound.) is produced, for example, by suspending the first compound, the conductive agent, and the binder in an appropriate solvent, applying the suspension to a current collector, drying the suspension, and pressing the current collector. A blending ratio of the first compound, the conductive agent and the binder is preferably 80 to 95 wt % for the first compound, 3 to 18 wt % for the conductive agent, and 2 to 7 wt % for the binder. Each of the lithium metal foil and the lithium alloy foil may each be used as the negative electrode active material-containing layer.

The negative electrode may further include a negative electrode current collector. The negative electrode current collector includes a foil or mesh containing a metal such as copper, nickel, or aluminum. The negative electrode current collector can be in contact with the negative electrode active material-containing layer. The negative electrode current collector is desirably electrically connected to a negative electrode terminal via a lead.

The negative electrode current collector may be differed depending on the type of the negative electrode active material. In a case where lithium metal, a lithium alloy, graphite, a carbonaceous material, a Si/graphite composite material obtained by compositing a Si powder and a graphite powder, lithium-containing graphite in which lithium ions are inserted in advance, or a lithium-containing carbonaceous material in which lithium ions are inserted in advance is used as the negative electrode active material, copper can be used for the negative electrode current collector. In a case where a titanium-containing oxide or niobium-containing oxide is used for the negative electrode active material, the negative electrode current collector can contain at least one of aluminum or an aluminum alloy. A more preferable negative electrode current collector is an aluminum foil or an aluminum alloy foil. A purity of the aluminum foil is preferably 99.99% or more. The aluminum alloy is preferably an alloy containing an element such as magnesium, zinc or silicon. On the other hand, a content of transition metals such as iron, copper, nickel and chromium is preferably 100 ppm or less.

A thickness of the negative electrode current collector is 20 μm or less, and is more preferably 15 μm or less.

The negative electrode preferably has a capacity equal to or in excess of the positive electrode capacity.

The thickness of the negative electrode varies depending on the electrode shape and application. In a case where the electrode group structure is a stack structure or a wound structure, the negative electrode thickness is preferably 30 μm or more and 500 μm or less.

The negative electrode may include a film (for example, coating film) containing a lithium nitrogen compound. The film may be present on at least a part of a surface of the negative electrode. The film is desirably present on at least a part of a surface of the negative electrode active material, at least a part of a surface of the negative electrode current collector, or at least a part of each of the surfaces of the negative electrode active material and the negative electrode current collector. Accordingly, the effect of suppressing the reductive decomposition of the ionic liquid can be enhanced. The film may be present on a part of the target surface or may be present on the entire target surface. Examples of the lithium nitrogen compound include Li₃N. The film containing a lithium nitrogen compound may contain at least one atom selected from the group consisting of C, O, and F.

### <Separator>

The separator can be disposed on at least one surface of the positive electrode, on at least one surface of the negative electrode, or between the positive electrode and the negative electrode. The separator may be in contact with the positive electrode, the negative electrode, or the positive and negative electrodes, but may be integrated with the positive electrode, the negative electrode, or the positive and negative electrodes.

As the separator, a nonwoven fabric, a porous membrane, a membrane of a solid electrolyte having lithium ion conductivity, or a composite obtained by combining two or more of these can be used. Examples of the composite include a stack of a solid electrolyte membrane having lithium ion conductivity and a nonwoven fabric or a porous membrane. As a material for the nonwoven fabric, a polymer such as cellulose is used. As the porous membrane, for example, a polyethylene (PE) membrane, a polypropylene (PP) membrane, or a polyimide membrane is used.

The separator may be porous. The separator can have a porosity of 60% or more and 80% or less. Accordingly, even though the ionic liquid has high viscosity, the separator can contain a sufficient amount of the nonaqueous electrolyte.

A thickness of the separator can be 5 μm or more and 50 μm or less.

Inorganic oxide particles can be present on any one of a surface of the separator, the surface of the positive electrode in contact with the separator, and the surface of the negative electrode in contact with the separator, or any combination thereof. The inorganic oxide particles can be present on a part or the whole of the target surface. This makes it possible to keep a high insulation property with the negative electrode, for example, the negative electrode containing lithium metal. Examples of the inorganic oxide particles include alumina particles, titania particles, and lithium conductive solid electrolyte particles.

The separator may have lithium ion conductivity. Examples of the separator having lithium ion conductivity include a separator containing at least one selected from the group consisting of an oxide having lithium ion conductivity, a sulfide having lithium ion conductivity, a phosphate having lithium ion conductivity, a polymer having lithium ion conductivity, and a solid electrolyte having lithium ion conductivity. The lithium ion conductive separator can be a composite further containing an inorganic substance and/or an organic substance in addition to the above components.

The lithium ion conductive separator may be a layered substance or a film-like substance.

As the lithium ion conductive separator, a separator obtained by compositing a lithium ion conductive inorganic solid electrolyte with a polymer may be used. This separator has flexibility. The separator can selectively transmit lithium ions. The separator has a non-porous or non-communicating structure. Examples of the polymer include polyethylene oxide (PEO), polyethylene terephthalate, and polyvinylidene fluoride (PVdF). The separator may contain a lithium salt. A proportion of the lithium salt to a total of the lithium salt and the polymer can be 0 to 50 wt %. The separator preferably contain, as the lithium salt, at least one of LiFSI or LiTFSI. A content of the inorganic solid electrolyte in the separator can be in a range of 10 wt % or more and 90 wt % or less. By using this separator, only lithium ions can selectively move in the separator. And this separator restricts movement of anion species and cation species from the positive electrode to the separator, and also restricts movement of ions other than lithium ions from the negative electrode to the separator.

The lithium ion conductive solid electrolyte desirably has a lithium ion conductivity at 25° C. of 1×10⁻⁴ S/cm or more, more preferably 1×10⁻³ S/cm or more.

Examples of the lithium ion conductive solid electrolyte include an oxide solid electrolyte having a garnet type structure and a lithium phosphoric acid solid electrolyte having a NASICON type structure.

The oxide solid electrolyte having a garnet type structure has advantages of high reduction resistance and a wide electrochemical window. Examples of the oxide solid electrolyte having a garnet type structure having a lithium ion conductivity at 25° C. of 1×10⁻³ S/cm or more include La₅₊ₓAₓLa₃₋ₓM₂O₁₂ (A is at least one selected from the group consisting of Ca, Sr and Ba, M is at least one selected from the group consisting of Nb and Ta, and 0≤x≤0.5), Li₃M₂₋ₓL₂O₁₂ (M is at least one selected from the group consisting of Ta and Nb, L may contain Zr, and 0≤x≤0.5), Li₇₋₃ₓAlₓLa₃Zr₃O₁₂ (0≤x≤0.5), and Li₇La₃Zr₂O₁₂. Li_{6.25}Al_{0.25}La₃Zr₃O₁₂ and Li₇La₃Zr₂O₁₂ each have high ionic conductivity and electrochemical stability, and thus a secondary battery having excellent discharge performance and cycle life performance can be realized.

Examples of the lithium phosphate solid electrolyte having a NASICON type structure having a lithium ion conductivity at 25° C. of 1×10⁻⁴ S/cm or more include a substance represented by LiM₂(PO₄)₃ (M is at least one selected from the group consisting of Si, Ti, Ge, Sr, Zr, Sn, Al, and Ca). A substance represented by Li_{1+y}AlₓM₂₋ₓ(PO₄)₃ (M represents one or more selected from the group consisting of Si, Ti, Ge, Sr, Zr, and Ca, 0≤x≤1, and 0≤y≤1) is preferable. Li₁₊ₓAlₓGe₂₋ₓ(PO₄)₃ (0≤x≤0.5 and 0≤y≤1), Li₁₊ₓAlₓZr₂₋ₓ(PO₄)₃ (0≤x≤0.5), and Li₁₊ₓAlₓTi₂₋ₓ(PO₄)₃ (0≤x≤0.5) each have high ionic conductivity and high electrochemical stability, and thus are preferred.

The solid electrolyte may contain inevitable impurities other than those listed above. The type of the solid electrolyte used may be one or two or more.

The thickness of the separator can be 20 μm or more and 200 μm or less. Within this range, the separator has practical mechanical strength and can reduce the resistance of ion conduction.

### <Container Member>

The secondary battery may include a container member. The container member includes a container having an opening, and a lid attached to the opening of the container. The lid may be a member separate from or integrated with the container. In addition, the container member only needs to be capable of housing the positive electrode, the negative electrode, the separator, and the nonaqueous electrolyte, and is not limited to the structure shown in the drawings. A container member having a shape corresponding to an angular, thin, cylindrical, or coin-shaped battery may be used.

Materials constituting the container member include metal and a laminate film.

Examples of the metal include iron, stainless steel, aluminum, and nickel. In a case where a metal can is used for the container, a plate thickness of the container is desirably set to 0.5 mm or less, and a more preferred range is 0.3 mm or less.

Examples of the laminated film include a multilayer film in which an aluminum foil or stainless foil is covered with a resin film. As the resin, polymers such as polypropylene (PP), polyethylene (PE), nylon and polyethylene terephthalate (PET) can be used. The thickness of the laminated film is preferably 0.2 mm or less.

### <Manufacturing Method>

The secondary battery according to the embodiment can be manufactured, for example, as follows.

A method for manufacturing a secondary battery includes: preparing an electrode on which a film containing a lithium nitrogen compound is not formed as a negative electrode; preparing an electrode on which a nitrogen-containing film is not formed as a positive electrode; preparing a nonaqueous electrolyte; housing the negative electrode and the positive electrode in a container member; injecting the nonaqueous electrolyte into the container member; sealing the container member to obtain a battery precursor; and performing a first cycle of charge and discharge on the battery precursor.

The negative electrode on which a film containing a lithium nitrogen compound is not formed is produced, for example, by the following method. A plate or foil containing at least one of Li metal or Li alloy is fixed (for example, pressure-bonded) to a current collector. In addition, a plate or foil containing at least one of Li metal or Li alloy may be used as an electrode. Alternatively, the negative electrode is produced, for example, by suspending a compound capable of allowing Li to be inserted in and extracted from, a conductive agent and a binder in a solvent, applying the suspension to a current collector, drying the suspension, and pressing the current collector.

The positive electrode on which a nitrogen-containing film is not formed is produced, for example, by the following method. A positive electrode active material, a conductive agent, and a binder are suspended in a solvent to prepare a slurry. The slurry is applied onto one side or both sides of a current collector. Then, the applied slurry is dried to obtain a stack of an active material-containing layer and the current collector. Then, the stack is subjected to pressing. The positive electrode is produced in this manner. Alternatively, the positive electrode may be produced by the following method. First, a positive electrode active material, a conductive agent, and a binder are mixed to obtain a mixture. Next, the mixture is formed into pellets. The positive electrode can then be obtained by disposing these pellets on the current collector.

As the nonaqueous electrolyte, a nonaqueous electrolyte containing an ionic liquid and 0.5 wt % or more and 30 wt % or less of a urea compound is prepared.

In the first cycle of charge and discharge, for example, charge and discharge are performed a plurality of times at a temperature of room temperature (for example, 25° C.) or higher and 45° C. or lower and at a current rate of 0.2 C or more and 1 C or less. 1 C is a current value at which the nominal capacity of the secondary battery is discharged in one hour.

The battery precursor may be subjected to a storage (aging) treatment before the first cycle of charge and discharge.

Next, a method for checking the nonaqueous electrolyte, the positive electrode active material, the negative electrode active material, and the like will be described.

### <Method for Confirming Composition of Nonaqueous Electrolyte>

A method for identifying the components of the nonaqueous electrolyte will be described by exemplifying a case where the nonaqueous electrolyte is included in the secondary battery.

First, the secondary battery including the nonaqueous electrolyte to be measured is discharged at 0.1 C until the battery voltage reaches 1.0 V. The discharged secondary battery is disassembled in a glove box in an inert atmosphere. Next, the nonaqueous electrolyte included in the battery and the electrode group is extracted. In a case where the nonaqueous electrolyte can be taken out from a location where the battery is opened, the nonaqueous electrolyte is sampled as it is. On the other hand, in a case where the nonaqueous electrolyte to be measured is held in the electrode group, the electrode group is further disassembled, and, for example, the separator impregnated with the nonaqueous electrolyte is taken out. The nonaqueous electrolyte impregnated in the separator can be extracted using, for example, a centrifuge. Thus, the nonaqueous electrolyte can be sampled. When the amount of the nonaqueous electrolyte included in the secondary battery is small, the nonaqueous electrolyte can be extracted by immersing the electrode and the separator in an acetonitrile solution. A weight of the acetonitrile solution is measured before and after extraction, and an amount of the nonaqueous electrolyte extracted can be calculated.

The thus obtained nonaqueous electrolyte sample is subjected to, for example, a gas chromatography mass spectrometry apparatus (GC-MS) or nuclear magnetic resonance (NMR) spectroscopy to perform composition analysis. In the analysis, first, components contained in the nonaqueous electrolyte are identified. Next, a calibration curve of each component is created. In a case where a plurality of types are included, a calibration curve for each component is created. The composition of the nonaqueous electrolyte can be determined by comparing the created calibration curve with the peak intensity or area in the result obtained by measuring the sample of the nonaqueous electrolyte.

A moisture content of the nonaqueous electrolyte sample prepared as described above is measured by a coulometric titration method using a Karl Fischer moisture meter (Model VA-06, manufactured by Mitsubishi Chemical Analytech Co., Ltd., or an apparatus having a function equivalent thereto). Specifically, measurement is performed under conditions that the sample is heated to 140° C. and that nitrogen gas is flown at a flow rate of 200 ml/min. The moisture amount is converted from an amount of electricity consumed in a reaction between water and iodine. Thus, the water content of the nonaqueous electrolyte is obtained.

### <Method for Confirming Composition of Electrode>

First, a method of taking out the electrode (positive electrode or negative electrode) from the battery will be described.

The secondary battery is disassembled in an argon atmosphere, and the positive electrode or the negative electrode to be measured is taken out. The object to be measured is washed with a solvent including dimethyl carbonate in an argon atmosphere, dried under vacuum at 100° C., and then measured by the method which will be described below.

### <Positive Electrode Active Material>

The crystal structure and elemental composition of the positive electrode active material can be confirmed by powder X-ray diffraction (XRD) measurement and inductively coupled plasma (ICP) emission spectroscopy.

### <Negative Electrode Active Material>

The crystal structure and elemental composition of the negative electrode active material can be confirmed by powder X-ray diffraction (XRD) measurement and inductively coupled plasma (ICP) emission spectroscopy.

### <Method for Confirming Nitrogen-Containing Film or the Like>

Whether or not the nitrogen-containing film is present on the positive electrode or the lithium nitrogen compound is present in the negative electrode can be confirmed by X-ray photoelectron spectroscopy (XPS) under the conditions which will be described below.

As an XPS apparatus, Quantera SXM manufactured by ULVAC-PHI, Inc. or an apparatus having a function equivalent thereto can be used. As an excitation X-ray source, a single-crystal spectroscopic Al-Kα ray (1486.6 eV) is used. An X-ray output is 4 kW (13 kV×310 mA), a photoelectron detection angle is 45°, and an analysis area is about 4 mm×0.2 mm. Scanning is performed at 0.10 eV/step.

For example, the presence of Li₃N can be confirmed by detecting a spectrum derived from a Li—N bond (399 eV) by state analysis of a surface (Nis) of a negative electrode current collector (for example, an aluminum foil).

Next, the secondary battery according to the embodiment will be described, with reference to the drawings.

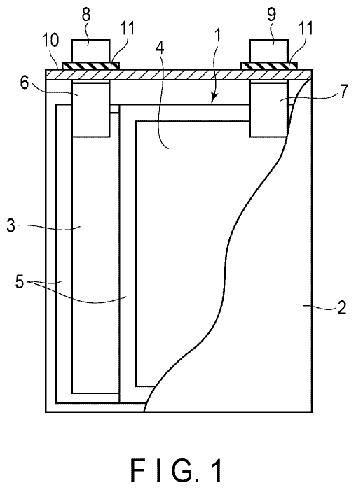

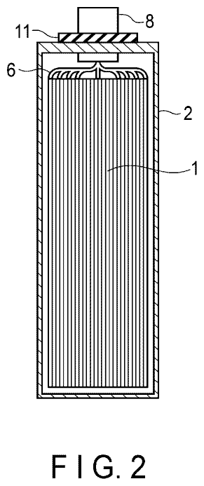

FIGS. 1 and 2 show an example of the secondary battery using a metal container.

An electrode group 1 is stored in a rectangular tubular metal container 2. The electrode group 1 has a structure formed by spirally winding the positive electrode active material-containing layer of a positive electrode 3 and the negative electrode active material-containing layer of a negative electrode 4 with a separator 5 interposing therebetween so as to form a flat shape. The separator 5 covers the surface (principal surface) of the positive electrode active material-containing layer or negative electrode active material-containing layer. As shown in FIG. 2, a strip-shaped positive electrode lead 6 is electrically connected to each of a plurality of portions at an end of the positive electrode 3 located on an end face of the electrode group 1. A strip-shaped negative electrode lead 7 is electrically connected to each of a plurality of portions at an end of the negative electrode 4 located on the end face. The plurality of positive electrode leads 6 are bundled, and in this state, electrically connected to a positive electrode tab 8. A positive electrode terminal is formed from the positive electrode leads 6 and the positive electrode tab 8. In addition, the negative electrode leads 7 are bundled, and in this state, electrically connected to a negative electrode tab 9. A negative electrode terminal is formed from the negative electrode leads 7 and the negative electrode tab 9. A sealing plate 10 made of a metal is fixed to the opening portion of the metal container 2 by welding or the like. The positive electrode tab 8 and the negative electrode tab 9 are extracted to the outside from outlet holes formed in the sealing plate 10, respectively. The inner circumference surface of each outlet hole of the sealing plate 10 is covered with an insulating member 11 to avoid a short circuit caused by contact between the positive electrode tab 8 and the negative electrode tab 9.

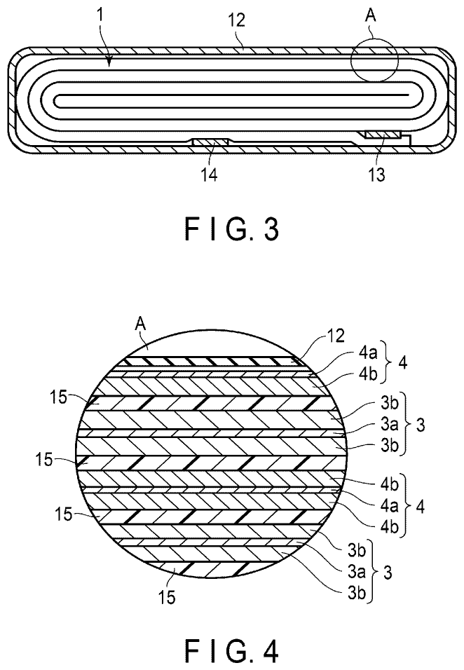

FIGS. 3 and 4 show an example of a secondary battery using a container member made of a laminated film.

As shown in FIGS. 3 and 4, the flat wound electrode group 1 is stored in a sack-shaped container 12 made of a laminated film including a metal layer interposing between two resin films. The flat wound electrode group 1 is formed by spirally winding a stacked structure obtained by stacking the negative electrode 4, a separator 15, the positive electrode 3, and the separator 15 from the outside, and pressing the wound structure. The outermost negative electrode 4 has an arrangement in which a negative electrode active material-containing layer 4b containing a negative electrode active material on one surface on the inner side of a negative electrode current collector 4a, as shown in FIG. 4, and the remaining negative electrodes 4 are arranged by forming the negative electrode active material-containing layers 4b on both surfaces of the negative electrode current collector 4a. The positive electrode 3 is arranged by forming positive electrode active material-containing layers 3b on both surfaces of a positive electrode current collector 3a.

Near the outer end of the wound electrode group 1, a negative electrode terminal 13 is electrically connected to the negative electrode current collector 4a of the outermost negative electrode 4, and a positive electrode terminal 14 is electrically connected to the positive electrode current collector 3a of the positive electrode 3 on the inner side. The negative electrode terminal 13 and the positive electrode terminal 14 extend outward from the opening portion of the sack-shaped container 12. The opening portion of the sack-shaped container 12 is heat-sealed, thereby sealing the wound electrode group 1. At the time of heat-sealing, the negative electrode terminal 13 and the positive electrode terminal 14 are sandwiched by the sack-shaped container 12 in the opening portion.

The secondary battery according to the embodiment described above includes: a positive electrode; a negative electrode containing at least one selected from the group consisting of lithium metal, a lithium alloy, and a compound capable of allowing Li to be inserted in and extracted from; and a nonaqueous electrolyte containing an ionic liquid and 0.5 wt % or more and 30 wt % or less of a urea compound. Therefore, it is possible to provide a secondary battery having a high energy density and excellent cycle performance and discharge rate performance.

### Second Embodiment

A battery module of the second embodiment includes a plurality of the secondary batteries according to the embodiment.

Examples of the battery module include those including a plurality of single batteries electrically connected in series and/or in parallel as a constituent unit, and those including a first unit including a plurality of single batteries electrically connected in series or a second unit including a plurality of single batteries electrically connected in parallel. The battery module may include at least one of these configurations.

Examples of the form in which a plurality of secondary batteries are electrically connected in series and/or in parallel include those in which a plurality of batteries each having a container member are electrically connected in series and/or in parallel, and those in which a plurality of electrode groups or bipolar type electrode bodies housed in a common housing are electrically connected in series and/or in parallel. In a specific example of the former, the positive electrode terminals and the negative electrode terminals of a plurality of secondary batteries are connected by a metal bus bar (e.g., aluminum, nickel, copper). In a specific example of the latter, a plurality of electrode groups or bipolar type electrode bodies are housed in a single housing in a state of being electrochemically insulated by partition walls, and are electrically connected in series. In the case of secondary batteries, the number of batteries to be electrically connected in series is set within the range of 5 to 7, so that the voltage compatibility with lead storage batteries is improved. In order to improve the voltage compatibility with the lead storage batteries, it is preferable to connect five or six single batteries in series.

A metal can made of an aluminum alloy, iron, stainless steel or the like, a plastic container, or the like can be used for the housing that houses the battery module. Further, the plate thickness of the container is desirably 0.5 mm or more.

The battery module according to the embodiment described above includes the secondary battery of the embodiment, and thus can realize a battery module high in energy density and excellent in cycle performance and discharge rate performance.

### Third Embodiment

A battery pack according to the third embodiment can include one or more secondary batteries (single batteries) according to the embodiment. A plurality of secondary batteries may be electrically connected in series, in parallel, or in a combination of series and parallel to constitute a battery module. The battery pack according to the embodiment may include a plurality of battery modules.

The battery pack according to the embodiment may further include a protective circuit. The protective circuit has a function of controlling charge/discharge of the secondary battery. Alternatively, a circuit included in a device that uses the battery pack as a power source (for example, an electronic device, an automobile, etc.) can be used as the protective circuit for the battery pack.

Moreover, the battery pack according to the embodiment may further include an external power distribution terminal. The external power distribution terminal is configured to externally output current from the secondary battery, and to input current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the embodiment will be described with reference to the drawings.

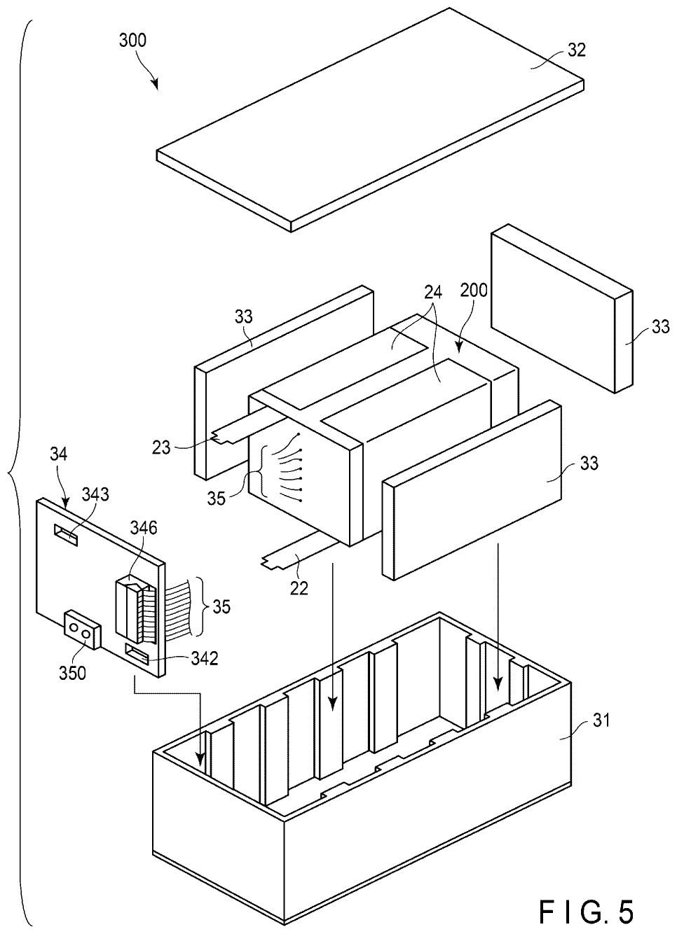

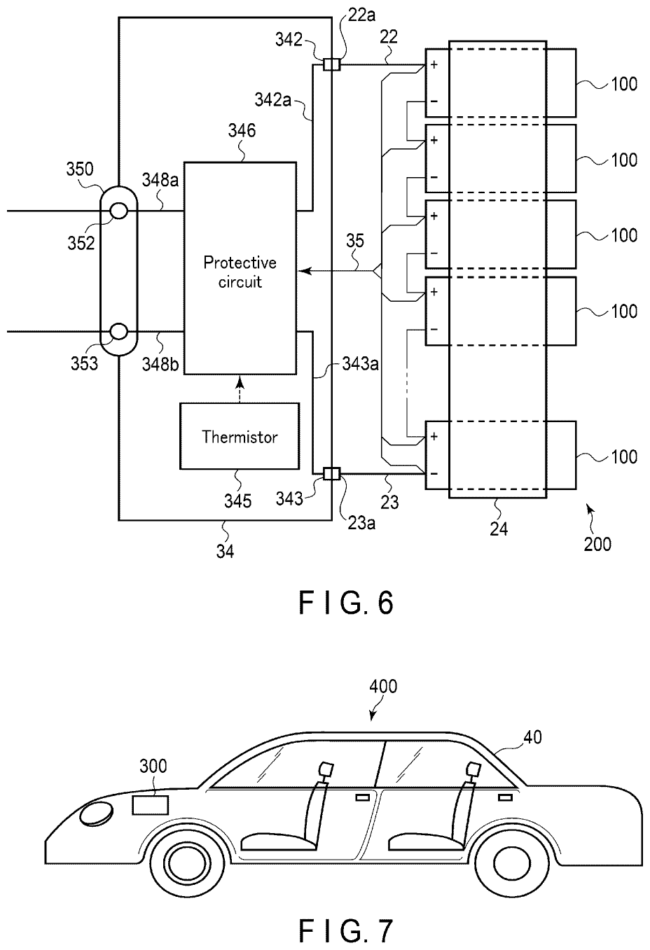

FIG. 5 is an exploded perspective view schematically showing an example of the battery pack according to the embodiment. FIG. 6 is a block diagram showing an example of an electric circuit of the battery pack shown in FIG. 5.

A battery pack 300 shown in FIGS. 5 and 6 includes a housing container 31, a lid 32, protective sheets 33, a battery module 200, a printed wiring board 34, wires 35, and an insulating plate (not shown).

The housing container 31 shown in FIG. 5 is a square-bottomed container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tape(s) 24.

At least one of the plural single-batteries 100 is a battery according to the embodiment. The plural single-batteries 100 are electrically connected in series, as shown in FIG. 6. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 24 fastens the plural single-batteries 100. The plural single-batteries 100 may be fixed using a heat shrinkable tape in place of the adhesive tape(s) 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side (positive-side) wiring 348a, and a minus-side (negative-side) wiring 348b. One principal surface of the printed wiring board 34 faces a side surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on the inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery 100. When detecting over charge or the like for each of the single-batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may not be needed. In this case, the positive electrode-side lead 22 and the negative electrode-side lead 23 may respectively be used as the positive-side terminal and negative-side terminal of the external power distribution terminal.

Such a battery pack is used, for example, in applications where excellent cycle performance is demanded when a large current is extracted. More specifically, the battery pack is used as, for example, a power source for electronic devices, a stationary battery, or an onboard battery for various kinds of vehicles and railway cars. An example of the electronic device is a digital camera. The battery pack is particularly favorably used as an onboard battery.

The battery pack according to the embodiment includes the secondary battery according to the embodiment or the battery module according to the embodiment. Therefore, a battery pack having a high energy density and excellent cycle performance and discharge rate performance.

### Fourth Embodiment

According to a fourth embodiment, a vehicle is provided. This vehicle includes the battery pack according to the embodiment.

In the vehicle according to the embodiment, the battery pack is intended, for example, for recovering regenerative energy of power of the vehicle. The vehicle may include a mechanism (for example, a regenerator) that converts kinetic energy of the vehicle into regenerative energy.

Examples of the vehicle according to the embodiment include two-wheel to four-wheel hybrid electric automobiles, two-wheel to four-wheel electric automobiles, assisted bicycles, and railway vehicles.

The mounting position of the battery pack in the vehicle according to the embodiment is not particularly limited. For example, when the battery pack is mounted in an automobile, the battery pack can be mounted in the engine room of the vehicle, in a rear part of the vehicle, or under the seat.

The vehicle according to the embodiment may include a plurality of battery packs. In this case, the batteries included in the respective battery packs may be electrically connected in series, may be electrically connected in parallel, or may be electrically connected in a combination of series and parallel. For example, when each of the battery packs includes a battery module, the battery modules may be electrically connected in series, may be electrically connected in parallel, or may be electrically connected in a combination of series and parallel. Alternatively, when each of the battery packs includes a single battery, the respective batteries may be electrically connected in series, may be electrically connected in parallel, or may be electrically connected in a combination of series and parallel.

An example of the vehicle according to the embodiment is explained below, with reference to the drawings.

FIG. 7 is a partially see-through diagram schematically showing an example of a vehicle according to the embodiment.

A vehicle 400, shown in FIG. 7 includes a vehicle body 40 and a battery pack 300 according to the third embodiment. In the example shown in FIG. 7, the vehicle 400 is a four-wheeled automobile.

This vehicle 400 may have plural battery packs 300 installed. In such a case, the batteries (e.g., single-batteries or battery module) included in the battery packs 300 may be connected in series, connected in parallel, or connected in a combination of in-series connection and in-parallel connection.

In FIG. 7, depicted is an example where the battery pack 300 is installed in an engine compartment located at the front of the vehicle body 40. As mentioned above, for example, the battery pack 300 may be alternatively installed in rear sections of the vehicle body 40, or under a seat. The battery pack 300 may be used as a power source of the vehicle 400. The battery pack 300 can also recover regenerative energy of motive force of the vehicle 400.

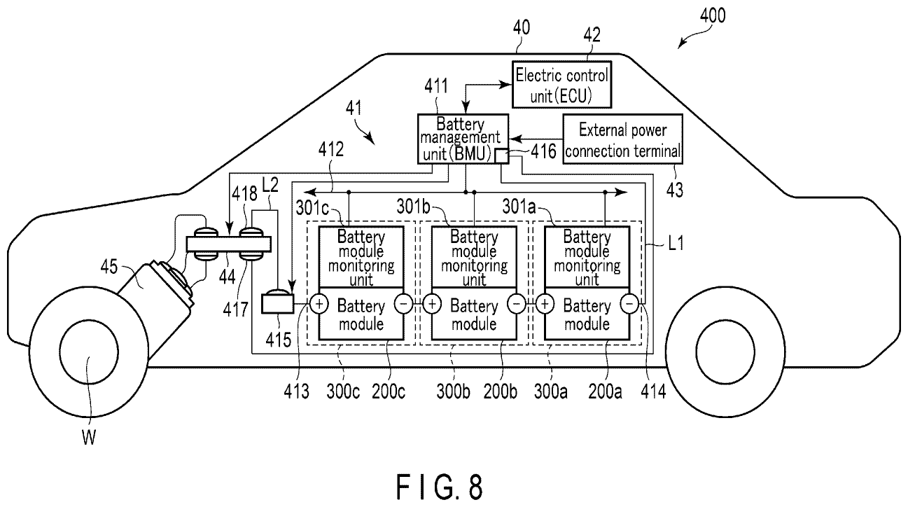

Next, with reference to FIG. 8, an aspect of operation of the vehicle according to the embodiment is explained.

FIG. 8 is a diagram schematically showing an example of a control system related to an electric system in the vehicle according to the embodiment. A vehicle 400, shown in FIG. 8, is an electric automobile.

The vehicle 400, shown in FIG. 8, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 8, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

The battery pack 300a includes a battery module 200a and a battery module monitoring unit 301a (e.g., a VTM:voltage temperature monitoring). The battery pack 300b includes a battery module 200b and a battery module monitoring unit 301b. The battery pack 300c includes a battery module 200c and a battery module monitoring unit 301c. The battery packs 300a to 300c are battery packs similar to the aforementioned battery pack 300, and the battery modules 200a to 200c are battery modules similar to the aforementioned battery module 200. The battery modules 200a to 200c are electrically connected in series. The battery packs 300a, 300b and 300c can each be independently removed, and may be exchanged by a different battery pack 300.

Each of the battery modules 200a to 200c includes plural single-batteries connected in series. At least one of the plural single-batteries is the secondary battery according to the embodiment. The battery modules 200a to 200c each perform charging and discharging via a positive electrode terminal 413 and a negative electrode terminal 414.

The battery management unit 411 performs communication with the battery module monitoring units 301a to 301c and collects information such as voltages or temperatures for each of the single-batteries 100 included in the battery modules 200a to 200c included in the vehicle power source 41. In this manner, the battery management unit 411 collects information concerning security of the vehicle power source 41.

The battery management unit 411 and the battery module monitoring units 301a to 301c are connected via the communication bus 412. In communication bus 412, a set of communication lines is shared at multiple nodes (i.e., the battery management unit 411 and one or more battery module monitoring units 301a to 301c). The communication bus 412 is, for example, a communication bus configured based on CAN (Control Area Network) standard.

The battery module monitoring units 301a to 301c measure a voltage and a temperature of each single-battery in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 8) for switching on and off electrical connection between the positive electrode terminal 413 and the negative electrode terminal 414. The switch unit 415 includes a precharge switch (not shown), which is turned on when the battery modules 200a to 200c are charged, and a main switch (not shown), which is turned on when output from the battery modules 200a to 200c is supplied to a load. The precharge switch and the main switch each include a relay circuit (not shown), which is switched on or off based on a signal provided to a coil disposed near the switch elements. The magnetic contactor such as the switch unit 415 is controlled based on control signals from the battery management unit 411 or the vehicle ECU 42, which controls the operation of the entire vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411 or the vehicle ECU 42, which controls the entire operation of the vehicle. Due to the inverter 44 being controlled, output voltage from the inverter 44 is adjusted.

The drive motor 45 is rotated by electric power supplied from the inverter 44. The drive generated by rotation of the motor 45 is transferred to an axle and driving wheels W via a differential gear unit, for example.

The vehicle 400 also includes a regenerative brake mechanism (i.e., a regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connecting line Li is connected to the negative electrode terminal 414 of the vehicle power source 41. The other terminal of the connecting line Li is connected to a negative electrode input terminal 417 of the inverter 44. A current detector (current detecting circuit) 416 in the battery management unit 411 is provided on the connecting line Li in between the negative electrode terminal 414 and negative electrode input terminal 417.

One terminal of a connecting line L2 is connected to the positive electrode terminal 413 of the vehicle power source 41. The other terminal of the connecting line L2 is connected to a positive electrode input terminal 418 of the inverter 44. The switch unit 415 is provided on the connecting line L2 in between the positive electrode terminal 413 and the positive electrode input terminal 418.

The external terminal 43 is connected to the battery management unit 411. The external terminal 43 is able to connect, for example, to an external power source.

The vehicle ECU 42 performs cooperative control of the vehicle power source 41, switch unit 415, inverter 44, and the like, together with other management units and control units including the battery management unit 411 in response to inputs operated by a driver or the like. Through the cooperative control by the vehicle ECU 42 and the like, output of electric power from the vehicle power source 41, charging of the vehicle power source 41, and the like are controlled, thereby performing the management of the whole vehicle 400. Data concerning the security of the vehicle power source 41, such as a remaining capacity of the vehicle power source 41, are transferred between the battery management unit 411 and the vehicle ECU 42 via communication lines.

The vehicle according to the embodiment includes the battery pack according to the embodiment. Therefore, it is possible to realize a vehicle having excellent traveling performance in a wide temperature range from low temperature to high temperature.

### Fifth Embodiment

According to a fifth embodiment, a stationary power supply is provided. The stationary power supply includes the battery pack according to the embodiment. The stationary power supply may include the secondary battery or battery module according to the embodiment, instead of the battery pack according to the embodiment.

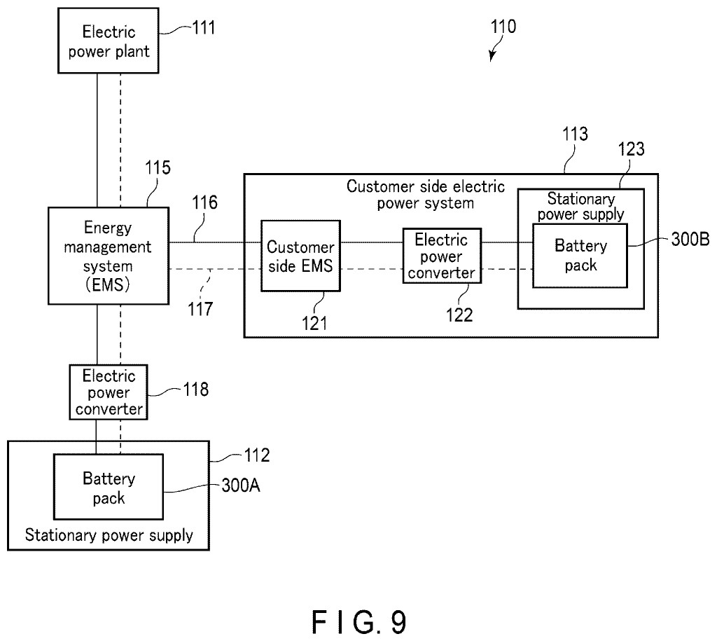

FIG. 9 is a block diagram showing an example of a system including a stationary power supply according to the embodiment. FIG. 9 is a diagram showing an application example to stationary power supplies 112, 123 as an example for use of the battery packs 300A, 300B according to the embodiment. In the example shown in FIG. 9, a system 110 in which the stationary power supplies 112, 123 are used is shown. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control operations to stabilize the entire system 110 by utilizing the electric power network 116 and the communication network 117.

The electric power plant 111 generates a large amount of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current and alternate current, conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control operations to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric car. Also, the system 110 may be provided with a natural energy source. In such a case, the natural energy source generates electric power through natural energy such as wind power and solar light. In addition to the electric power plant 111, electric power is also supplied from the natural energy source through the electric power network 116.

A stationary power supply according to the embodiment includes the battery pack according to the embodiment. Therefore, according to the present embodiment, a stationary power supply including a battery pack having high energy density and excellent in cycle performance and discharge rate performance can be provided.

### EXAMPLES

Hereinafter, examples of the present invention will be described in detail with reference to the drawings, but the present invention is not limited to the examples which will be described below.

### Example 1

As a positive electrode active material, lithium nickel cobalt manganese composite oxide (LiNi_{0.8}Co_{0.1}Mn_{0.1}O₂) particles having a layered structure and an average particle size of 3 μm were used. In the positive electrode active material particles, 8 wt % of graphite powder relative to the positive electrode active material-containing layer as a conductive agent and 5 wt % of PVdF relative to the positive electrode active material-containing layer as a binder were blended, and dispersed in an n-methylpyrrolidone (NMP) solvent to prepare a slurry. The slurry was applied to both surfaces of an aluminum alloy foil (purity: 99%) having a thickness of 15 μm so that an amount of the slurry to be applied per one side was 12.8 mg/cm². This was dried and pressed to produce a positive electrode having a thickness of a positive electrode active material-containing layer on one surface of 43 μm and an electrode density of 3.0 g/cm³. A specific surface area of the positive electrode active material-containing layer was 0.5 m²/g.

A lithium metal foil (purity: 99.9 wt %) having a thickness of 100 μm was pressure-bonded to a copper current collector foil having a thickness of 10 μm to produce a negative electrode. On the other hand, the positive electrode was covered with a separator of a porous polyethylene film having a thickness of 20 μm. The positive electrode, the separator, and the negative electrode were stacked so that the separator was disposed between the positive electrode active material-containing layer and the negative electrode active material-containing layer. Further, the positive electrode active material-containing layer was disposed so as to cover the negative electrode active material-containing layer with the separator interposed therebetween. The obtained stacked structure was spirally wound to produce an electrode group. Furthermore, the electrode group was further pressed and formed into a flat shape. This electrode group was housed in a thin metal can container made of an aluminum alloy (Al purity: 99%) having a thickness of 0.25 mm.

In a solvent made of an ionic liquid containing S222 cations and TFSI anions, 1.0 moL/kg of LiFSI was dissolved, and 5 wt % of urea was added to prepare a nonaqueous electrolytic solution. The moisture content of the nonaqueous electrolytic solution was measured by the method described above, and found to be 50 ppm by weight. The content of the ionic liquid (containing lithium ions) in the nonaqueous electrolytic solution was 95 wt %. The nonaqueous electrolytic solution was warmed to 60° C. and injected into the metal can under vacuum to produce a thin secondary battery having the above-described structure shown in FIG. 1 and having a thickness of 4 mm, a width of 30 mm, and a height of 50 mm. The battery capacity was 0.5 Ah, and the intermediate voltage was 3.75 V. The weight was 10 g.

### Examples 2 to 13

A thin secondary battery was produced in the same manner as described in Example 1, except that the solvent composition, the lithium salt, the lithium ion concentration, the urea compound and the addition amount, the negative electrode active material, and the positive electrode active material shown in Table 1 below were used.

MEITFSI represents an ionic liquid containing MEI cations and TFSI anions, PP13TFSI represents an ionic liquid containing PP13 cations and TFSI anions, DEMETFSI represents an ionic liquid containing DEME cations and TFSI anions, and DMPITFSI represents an ionic liquid containing DMPI cations and TFSI anions.

### Example 14

A thin secondary battery was produced in the same manner as in Example 1 described above, except that a negative electrode produced by the following method was used.

A graphite powder and polyvinylidene fluoride (PVdF) were mixed at a weight ratio of 90:10, and the resulting mixture was kneaded in the presence of an organic solvent (N-methylpyrrolidone) to prepare a slurry. The obtained slurry was applied to a copper foil having a thickness of 15 μm and dried, and the copper foil was pressed to obtain a negative electrode.

### Example 15

A thin secondary battery was produced in the same manner as in Example 1 described above, except that a negative electrode produced by the following method was used.

A graphite powder and a SiO powder were mixed at a weight ratio of 9:1, 10 wt % of polyvinylidene fluoride (PVdF) was added to the obtained negative electrode active material, and the obtained mixture was kneaded in the presence of an organic solvent (N-methylpyrrolidone) to prepare a slurry. The obtained slurry was applied to a copper foil having a thickness of 15 μm and dried, and the copper foil was pressed to obtain a negative electrode.

### Example 16

A thin secondary battery was produced in the same manner as in Example 1 described above, except that a negative electrode produced in the same manner as in Example 14 and a positive electrode active material described in detail below were used. LiFePO₄ particles have an olivine structure, an average particle size of 3 μm, and carbon fine particles (average particle size: 0.005 μm) adhered (adhesion amount: 0.1 wt %) to the particle surface.

### Example 17

A thin secondary battery was produced in the same manner as in Example 1 described above, except that a negative electrode produced by the following method and the positive electrode active material described in detail below were used.

As a negative electrode active material, TiNb₂O₇ particles having a monoclinic structure with an average particle size of 1 μm, a BET specific surface area of 3 m²/g, and a Li inserted potential of 1 to 2 V (vs. Li/Li⁺) were prepared. Negative electrode active material particles, a graphite powder having an average particle size of 5 μm and a BET specific surface area of 3 m²/g, a carbon nanofiber powder, and PVdF as a binder were blended at a weight ratio of 90:5:2:3, and dispersed in an n-methylpyrrolidone (NMP) solvent to prepare a slurry. The resulting slurry was applied to a 15 μm-thick aluminum alloy foil (purity: 99.3%), dried, and subjected to a pressing step to produce a negative electrode having a thickness of a negative electrode active material-containing layer on one surface of 59 μm and an electrode density of 2.2 g/cm³.

On the other hand, the positive electrode active material was particles of LiNi_{0.5}Mn_{1.5}O₄ with a spinel structure, whose average particle size was 5 μm.

### Example 18

A thin secondary battery was produced in the same manner as in Example 1 described above, except that a negative electrode produced by the following method was used.

A foil made of a Li_{0.9}Mg_{0.1} alloy and having a thickness of 50 μm was pressure-bonded to a copper foil current collector having a thickness of 10 μm to produce a negative electrode.

### Example 19

A thin secondary battery was produced in the same manner as in Example 1, except that lithium nickel cobalt manganese composite oxide (LiNi_{0.5}Co_{0.2}Mn_{0.3}O₂) particles having a layered structure and an average particle size of 3 μm were used as the positive electrode active material.

### Examples 20 and 21

A thin secondary battery was produced in the same manner as in Example 1 described above, except that the type of the urea compound was changed to the type shown in Table 2.

### Comparative Examples 1 to 6

A thin secondary battery was produced in the same manner as described in Example 1, except that the solvent composition, the lithium salt, the lithium ion concentration, the urea compound and the addition amount, the negative electrode active material, and the positive electrode active material shown in Table 2 below were used. The nonaqueous electrolytic solution of Comparative Example 6 is obtained by dissolving 1.0 moL/kg of LiFSI in a nonaqueous solvent containing dimethyl carbonate.

<Performance evaluation of Examples 1 to 15 and 18 to 21 and Comparative Examples 1 to 6>

Each secondary battery was charged with a constant current of 0.2 C to 4.2 V at 25° C., and then discharged with 0.2 C to 3.0 V as a first cycle of charge and discharge. A discharge capacity (Ah), average voltage (V), and energy (Wh) at the time of discharge were measured. The measurement results are shown in Tables 3 and 4. The average voltage was calculated from the relationship of V=Wh/Ah.

As a large current performance test (discharge rate performance test), each secondary battery was charged with a constant current of 0.2 C to 4.2 V at 25° C., and then discharged with 2 C to 3.0 V, and the discharge capacity was measured. A proportion of the obtained discharge capacity at the 2 C rate to the first cycle discharge capacity (discharge capacity at the 0.2 C rate) is shown as a 2 C discharge retention rate in Tables 3 and 4.

A cycle test of repeating a charge and discharge cycle in which each secondary battery was charged with a constant current of 0.2 C to 4.2 V at 45° C. and then discharged with a constant current of 0.2 C to 3.0 V was performed as a cycle test. The number of cycles in which the discharge capacity corresponding to 80% of the initial capacity was reached was defined as a cycle life at the time of the cycle test at 45° C. The measurement results are shown in Tables 3 and 4.

### <Performance Evaluation of Examples 16 and 17>

Each secondary battery was charged with a constant current of 0.2 C to 3.5 V at 25° C., and then discharged with 0.2 C to 2.0 V as a first cycle of charge and discharge. A discharge capacity (Ah), average voltage (V), and energy (Wh) at the time of discharge were measured. The measurement results are shown in Table 3. The average voltage was calculated from the relationship of V=Wh/Ah.

As a large current performance test (discharge rate performance test), each secondary battery was charged with a constant current of 0.2 C to 3.5 V at 25° C., and then discharged with 2 C to 2.0 V, and the discharge capacity was measured. A proportion of the obtained discharge capacity at the 2 C rate to the first cycle discharge capacity (discharge capacity at the 0.2 C rate) is shown as a 2 C discharge retention rate in Table 3.

A cycle test of repeating a charge and discharge cycle in which each secondary battery was charged with a constant current of 0.2 C to 3.5 V at 45° C. and then discharged with a constant current of 0.2 C to 2.0 V was performed as a cycle test. The number of cycles in which the discharge capacity corresponding to 80% of the initial capacity was reached was defined as a cycle life at the time of the cycle test at 45° C. The measurement results are shown in Table 3.

The number in parentheses following the description of the type of lithium salt in Tables 1 and 2 indicates the lithium ion concentration (moL/kg).

TABLE 1

| | | Lithium salt | | | | |
|---|---|---|---|---|---|---|
| | | (Li ion | Urea | | | |
| | Solvent | concentration, | compound | | Negative | Positive |
| Table 1 | composition | mol/kg) | Type | (wt. %) | electrode | electrode |
| Example 1 | [symbol] TFSI | LiFSI (1.0) | Urea | 5 | Li | LiNi [symbol] Co [symbol] Mn [symbol] O [symbol] |
| Example 2 | [symbol] TFSI | LiFSI (1.0) | Urea | [symbol] 0 | Li | LiNi [symbol] Co [symbol] Mn [symbol] O [symbol] |
| Example 3 | [symbol] TFSI | LiFSI ( [symbol] .0) | Urea | 20 | Li | LiNi [symbol] Co [symbol] Mn [symbol] O [symbol] |
| Example 4 | [symbol] TFSI | LiFSI (1.0) | Urea | 30 | Li | LiNi [symbol] Co [symbol] Mn [symbol] O [symbol] |
| Example 5 | [symbol] TFSI | LiFSI (2.0) | Urea | 2 | Li | LiNi [symbol] Co [symbol] Mn [symbol] O [symbol] |
| Example 6 | [symbol] TFSI | LiFSI (1.0) | Urea | 0.5 | Li | LiNi [symbol] Co [symbol] Mn [symbol] O [symbol] |
| Example 7 | [symbol] TFSI | LiFSI (0.5) | Urea | 5 | Li | LiNi [symbol] Co [symbol] Mn [symbol] O [symbol] |
| Example 8 | [symbol] TFSI | LiFSI (1.5) | Urea | 5 | Li | LiNi [symbol] Co [symbol] Mn [symbol] O [symbol] |
| Example 9 | [symbol] TFSI | LiFSI (2.0) | Urea | 5 | Li | LiNi [symbol] Co [symbol] Mn [symbol] O [symbol] |
| Example 10 | [symbol] TFSI | LiTFSI (1.0) | Urea | 5 | Li | LiNi [symbol] Co [symbol] Mn [symbol] O [symbol] |
| Example 11 | [symbol] TFSI | LiTFSI (2.0) | Urea | 5 | Li | LiNi [symbol] Co [symbol] Mn [symbol] O [symbol] |
| Example 12 | [symbol] TFSI | LiFSI (1.0) | Urea | 5 | Li | LiNi [symbol] Co [symbol] Mn [symbol] O [symbol] |
| Example 13 | [symbol] TFSI | LiFSI (2.0) | Urea | 5 | Li | LiNi [symbol] Co [symbol] Mn [symbol] O [symbol] |
| Example 14 | [symbol] TFSI | LiFSI (2.0) | Urea | 5 | Graphite | LiNi [symbol] Co [symbol] Mn [symbol] O [symbol] |
| Example 15 | [symbol] TFSI | LiFSI (1.0) | Urea | 5 | Graphite/Si | LiNi [symbol] Co [symbol] Mn [symbol] O [symbol] |
| | | | | | (9: [symbol] ) | |
| Example 16 | [symbol] FSI | LiFSI (1.0) | Urea | 5 | Graphite | LiFePO [symbol] |
| Example 17 | [symbol] FSI | LiFSI (1.0) | Urea | 5 | Nb [symbol] TiO [symbol] | LiNi [symbol] Mn [symbol] MnO [symbol] |

[symbol]

indicates data missing or illegible when filed

TABLE 2

| | | Lithium salt | | | | |
|---|---|---|---|---|---|---|
| | | (Li ion | Urea | | | |
| | Solvent | concentration, | compound | | Negative | Positive |
| Table 2 | composition | mol/kg) | Type | (wt. %) | electrode | electrode |
| Example 18 | [symbol] TFSI | LiFSI (1.0) | Urea | 5 | Li alloy | LiNi [symbol] Co [symbol] Mn [symbol] O [symbol] |
| Example 19 | [symbol] TFSI | LiFSI ( [symbol] .0) | Urea | 5 | Li | LiNi [symbol] Co [symbol] Mn [symbol] O [symbol] |
| Example 20 | [symbol] TFSI | LiFSI (1.0) | N-Methylurea | 5 | Li | LiNi [symbol] Co [symbol] Mn [symbol] O [symbol] |
| Example 21 | [symbol] TFSI | LiFSI (1.0) | N,N′- | 5 | Li | LiNi [symbol] Co [symbol] Mn [symbol] O [symbol] |
| | | | Dimethylpropyleneurea | | | |
| Comparative | [symbol] TFSI | LiFSI (2.0) | — | 0 | Li | LiNi [symbol] Co [symbol] Mn [symbol] O [symbol] |
| Example 1 | | | | | | |
| Comparative | [symbol] TFSI | LiFSI (2.0) | Urea | 15 | Li | LiNi [symbol] Co [symbol] Mn [symbol] O [symbol] |
| Example 2 | | | | | | |
| Comparative | [symbol] TFSI | LiFSI (2.0) | — | 0 | Li | LiNi [symbol] Co [symbol] Mn [symbol] O [symbol] |
| Example 3 | | | | | | |
| Comparative | [symbol] TFSI | LiFSI ( [symbol] .0) | — | 0 | Li | LiNi [symbol] Co [symbol] Mn [symbol] O [symbol] |
| Example 4 | | | | | | |
| Comparative | [symbol] TFSI | LiFSI ( [symbol] .0) | — | 0 | Li | LiNi [symbol] Co [symbol] Mn [symbol] O [symbol] |
| Example 5 | | | | | | |
| Comparative | Dimethyl | LiFSI (2.0) | — | 0 | Li | LiNi [symbol] Co [symbol] Mn [symbol] O [symbol] |
| Example 6 | carbonate | | | | | |

[symbol]

indicates data missing or illegible when filed

TABLE 3

| | Discharge | Average | | Cycle Life | 2 C discharge |
|---|---|---|---|---|---|
| | capacity | voltage | Energy | count at | retention |
| Table 3 | (Ah) | (V) | (Wh) | 45° C. | rate (%) |
| Example 1 | 1 | 3.75 | 3.75 | 500 | 80 |
| Example 2 | 0.98 | 3.75 | 3.675 | 450 | 75 |
| Example 3 | 0.96 | 3.7 | 3. [symbol] | 400 | 70 |
| Example 4 | 0.92 | 3.65 | 3.358 | 300 | 60 |
| Example 5 | 1 | 3.75 | 3.75 | 500 | 75 |
| Example 6 | 0.92 | 3.65 | 3.358 | 300 | 70 |
| Example 7 | 0.96 | 3.7 | 3. [symbol] | 400 | 75 |
| Example 8 | 1 | 3.7 | 3.7 | 500 | 75 |
| Example 9 | 0.96 | 3.65 | 3.584 | 560 | 70 |
| Example 10 | 1 | 3.75 | 3.75 | 400 | 75 |
| Example 11 | 0.96 | 3.7 | 3. [symbol] | 500 | 70 |
| Example 12 | 0.98 | 3.65 | 3.577 | 550 | 65 |
| Example 13 | 0.98 | 3.65 | 3.577 | 550 | 65 |
| Example 14 | 0.75 | 3.6 | 2.7 | 800 | 80 |
| Example 15 | 0.8 | 3.5 | 2.8 | 400 | 70 |
| Example 16 | 0.5 | 3.2 | 1.6 | 600 | 70 |
| Example 17 | 0.7 | 3.1 | 2.17 | 300 | 80 |

[symbol]

indicates data missing or illegible when filed

TABLE 4

| | Discharge | Average | | Cycle Life | 2 C discharge |
|---|---|---|---|---|---|
| | capacity | voltage | Energy | count at | retention |
| Table 4 | (Ah) | (V) | (Wh) | 45° C. | rate (%) |
| Example 18 | 1 | 3.7 | 3.7 | 620 | 75 |
| Example 19 | 0.9 | 3.75 | 3.375 | 550 | 80 |
| Example 20 | 0.96 | 3.75 | 3.6 | 600 | 75 |
| Example 21 | 0.96 | 3.75 | 3.6 | 580 | 75 |
| Comparative | 0.4 | 3.5 | 1.4 | 50 | 30 |
| Example 1 | | | | | |
| Comparative | 0.4 | 3.4 | [symbol] | 100 | 40 |
| Example 2 | | | | | |
| Comparative | 0.3 | 3.4 | 2.02 | 20 | 30 |
| Example 3 | | | | | |
| Comparative | 0.3 | 3.4 | 1.02 | 80 | 20 |
| Example 4 | | | | | |
| Comparative | 0.4 | [symbol] | 1.32 | 80 | 20 |
| Example 5 | | | | | |
| Comparative | 0.2 | 3.2 | 0.6 [symbol] | 50 | 30 |
| Example 6 | | | | | |

[symbol]

indicates data missing or illegible when filed

As is apparent from Tables 1 to 4, the secondary batteries of Examples 1 to 21 are high in energy and excellent in cycle life performance and discharge rate performance, as compared with Comparative Example 1 to 6.

Comparison between Example 1 and Comparative Examples 1 and 2 shows that, in a case where the nonaqueous electrolyte does not contain a urea compound or the content of the urea compound exceeds 30 wt %, all of energy, cycle life performance, and discharge rate performance are poor. In addition, from the results of Comparative Example 3 to 6, it is found that the same tendency is obtained even if the solvent composition is changed. Comparison among Examples 1 to 6 shows that Examples 1, 2, and 5 in which the content of the urea compound in the nonaqueous electrolyte is 1 wt % or more and 10 wt % or less are excellent in energy, cycle life performance, and discharge rate performance as compared with Examples 3, 4, and 6.

Comparison between Example 1 and Examples 10 to 13 shows that the secondary battery of Example 1 including a nonaqueous electrolyte containing an ionic liquid containing trialkylsulfonium cations, Li ions, TFSI anions, and FSI anions is excellent in discharge rate performance as compared with Examples 10 to 13.

Comparison between Example 1 and Examples 14,15, and 17 shows that the secondary battery of Example 1 including the negative electrode containing Li metal has high energy as compared with Examples 14, 15, and 17.

For the positive electrodes and the negative electrodes of the secondary batteries of Examples 1 to 21, the presence or absence of a coating film was confirmed by the XPS measurement described above, and it could be confirmed that a nitrogen-containing film was present on the surface of the positive electrode current collector and that a film containing Li₃N was present on the surface of the negative electrode.

Hereinafter, the inventions of the embodiments will be additionally described.
<1>. A secondary battery including:
a positive electrode;
a negative electrode including at least one selected from the group consisting of lithium metal, a lithium alloy, and a compound capable of allowing Li to be inserted and extracted; and
a nonaqueous electrolyte including an ionic liquid and 0.5 wt % or more and 30 wt % or less of a urea compound.
<2>. The secondary battery according to <1>, wherein the ionic liquid includes: at least one cation selected from the group consisting of a 1,3-dialkylimidazolium ion, a trialkylsulfonium ion, an N,N-dialkylpiperidinium ion, and a quaternary ammonium ion; a lithium ion; and an anion including at least one of [N(CF₃SO₂)₂]⁻ or [N(FSO₂)₂]⁻.
<3>. The secondary battery according to <1> or <2>, wherein the ionic liquid includes: at least one cation selected from the group consisting of a 1-ethyl-3-methylimidazolium ion, a triethylsulfonium ion, an N,N-dialkylpiperidinium ion, and a quaternary ammonium ion; a lithium ion; and an anion including at least one of [N(CF₃SO₂)]⁻ or [N(FSO₂)₂]⁻.
<4>. The secondary battery according to any one of <1> to <3>, wherein a concentration of the lithium ion in the nonaqueous electrolyte is in a range of 0.5 moL/kg or more and 2 moL/kg or less.
<5>. The secondary battery according to any one of <1> to <4>, wherein the urea compound includes at least one selected from the group consisting of urea, N-methylurea, and N,N′-dimethylpropyleneurea.
<6>. The secondary battery according to any one of <1> to <5>, wherein a content of the ionic liquid in the nonaqueous electrolyte is in a range of 70 wt % or more and 99.5 wt % or less.
<7>. The secondary battery according to any one of <1> to <6>, wherein the negative electrode includes at least one selected from the group consisting of the lithium metal, the lithium alloy, graphite, a carbonaceous material, and Li_{c}TiNb_{d}O₇ (0≤c≤5 and 1≤d≤<4).
<8>. A battery pack including the secondary battery according to any one of <1> to <7>.
<9>. The battery pack according to <8>, further including:
an external power distribution terminal; and
a protective circuit.
<10>. The battery pack according to <8> or <9>, further including a plurality of secondary batteries, the secondary batteries being electrically connected in series, in parallel, or in a combination of in series and in parallel.
<11>. A vehicle including the battery pack according to any one of <8> to <10>.
<12>. A stationary power supply including the battery pack according to any one of <8> to <10>.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
a positive electrode;
a negative electrode comprising at least one selected from the group consisting of lithium metal, a lithium alloy, and a compound capable of allowing Li to be inserted and extracted; and
a nonaqueous electrolyte comprising an ionic liquid and 0.5 wt % or more and 30 wt % or less of a urea compound.

2. The secondary battery according to claim 1, wherein the ionic liquid comprises: at least one cation selected from the group consisting of a 1,3-dialkylimidazolium ion, a trialkylsulfonium ion, an N,N-dialkylpiperidinium ion, and a quaternary ammonium ion; a lithium ion; and an anion comprising at least one of [N(CF₃SO₂)₂]⁻ or [N(FSO₂)₂]⁻.

3. The secondary battery according to claim 1, wherein the ionic liquid comprises: at least one cation selected from the group consisting of a 1-ethyl-3-methylimidazolium ion, a triethylsulfonium ion, an N,N-dialkylpiperidinium ion, and a quaternary ammonium ion; a lithium ion; and an anion comprising at least one of [N(CF₃SO₂)₂]⁻ or [N(FSO₂)₂]⁻.

4. The secondary battery according to claim 2, wherein a concentration of the lithium ion in the nonaqueous electrolyte is in a range of 0.5 moL/kg or more and 2 moL/kg or less.

5. The secondary battery according to claim 1, wherein the urea compound comprises at least one selected from the group consisting of urea, N-methylurea, and N,N′-dimethylpropyleneurea.

6. The secondary battery according to claim 1, wherein a content of the ionic liquid in the nonaqueous electrolyte is in a range of 70 wt % or more and 99.5 wt % or less.

7. The secondary battery according to claim 1, wherein the negative electrode comprises at least one selected from the group consisting of the lithium metal, the lithium alloy, graphite, a carbonaceous material, and Li_{c}TiNb_{d}O₇ (0≤c≤5 and 1≤d<4).

8. A battery pack comprising the secondary battery according to claim 1.

9. The battery pack according to claim 8, further comprising:
an external power distribution terminal; and
a protective circuit.

10. The battery pack according to claim 8, further comprising a plurality of secondary batteries, the secondary batteries being electrically connected in series, in parallel, or in a combination of in series and in parallel.

11. A vehicle comprising the battery pack according to claim 8.
